(19) United States
(12) Patent Application Publication
(10) Pub. No.: US 2010/0045911 A1
(43) Pub. Date: Feb. 25, 2010

(54) LIQUID CRYSTAL DISPLAY APPARATUS

(76) Inventor: Yoshifumi HIRAIDE, Tokyo (JP)

Correspondence Address: SMITH PATENT OFFICE, 1901 PENNSYLVANIA AVENUE N W, SUITE 901, WASHINGTON, DC, 20006, US

(21) Appl. No.: 12/248,591

(22) Filed: Oct. 9, 2008

(30) Foreign Application Priority Data
Aug. 19, 2008 (JP) 2008-237092

(51) Int. Cl. G02F 1/1333

(52) U.S. Cl. 349/122; 977/932

(57) ABSTRACT

The present invention provides a liquid crystal display apparatus to which fingerprints do not adhere for the purpose of improving transparency. A liquid crystal display apparatus is provided, wherein a nanoscale fingerprint adherence prevention surface layer is formed on the surface of a laminate of an LCD panel, contrast enhancement film, liquid crystal protective glass, and the like, using a method such as vacuum deposition or sputtering, taking one or multiple types selected from SiO2, Ti, Sn and the like as the principle components for the fingerprint adherence prevention surface layer.

### BACKGROUND OF THE INVENTION

1. Field of the Invention

The present invention relates to a liquid crystal display apparatus to which fingerprints do not adhere for the purpose of improving transparency.

2. Description of the Related Art

The number of touch panel products that can be mounted in portable telephones, personal computers, car navigation equipment, portable game machines and the like has grown in recent years, and the adoption of touch panels in electronic equipment used by individuals is expected to proliferate rapidly.

Nonetheless, “the surface becoming smudged with fingerprints” is a problem. Surface treatment for preventing adherence of fingerprints have been proposed to counter this problem.

Japanese Unexamined Laid-open Patent Application No. 2008-136963 discloses “a manufacturing method of a transparent protective material, and a portable terminal that provides the related protective material”, and a manufacturing method of a transparent protective material constituting the steps of coating a transparent substrate with a solution in which a fluorine resin is dissolved in a medium, and forming a fluorine resin film by evaporating the medium. However, there is the problem in this spin coating method that adjustments of the rotational speed and concentration produce fluctuations in the film thickness, refractive index changes, and the transparency is affected.

Japanese Unexamined Laid-open Patent Application No. H9-111185 discloses “a display for preventing smudging with fingerprints, and a coating solution for use with displays”, an object coated with a transparent hardening composition compounded with a silicone denatured acrylic copolymer, and fluctuations of film thickness are produced because the coating method uses a bar coater or dipping. Consequently, there is the problem of not being able to guarantee that the screen is completely free of fingerprint smudging.

### SUMMARY OF THE INVENTION

As a result of assiduous research, the present invention was invented to resolve the aforementioned problems. The present invention is: a liquid crystal display apparatus, wherein a fingerprint adherence prevention surface layer is formed into a nanoscale film on the surface of a laminate of an LCD panel, contrast enhancement film, liquid crystal protective glass, and the like using a method such as vacuum deposition or sputtering taking one or multiple types selected from SiO2, Ti, Sn and the like as the principle components; a liquid crystal display apparatus, wherein the fingerprint adherence prevention layer is formed at a nanoscale on the surface of a laminate of an LCD panel, air layer, liquid crystal protective glass, and the like, or on the surface of a laminate of an LCD panel, air layer, and electrostatic touch panel, and the like, or on the surface of a laminate of an LCD panel, air layer, resistance type touch panel, and the like; and a liquid crystal display apparatus capable of multi-function key pad display, wherein a fingerprint adherence prevention surface layer is formed into a nanoscale film on the surface of a laminate of an LCD panel, dome substrate, air layer, liquid crystal protective glass, and the like using a method such as vacuum deposition or sputtering taking one or multiple types selected from SiO2, Ti, Sn and the like as the principle components.

### BRIEF DESCRIPTION OF THE DRAWINGS

FIG. 1 is a cross-sectional diagram of a liquid crystal display related to the present invention;

FIG. 2 is a process diagram of the manufacturing of a liquid crystal display of the present invention;

FIG. 2A is a first process cross-sectional diagram of a liquid crystal display related to the present invention;

FIG. 2B is a second process cross-sectional diagram of a liquid crystal display related to the present invention;

FIG. 2C is a third process cross-sectional diagram of a liquid crystal display related to the present invention;

FIG. 2D is a fourth process cross-sectional diagram of a liquid crystal display related to the present invention;

FIG. 3 is a cross-section diagram of a liquid crystal display related to another embodiment of the present invention;

FIG. 4 is a cross-section diagram of a liquid crystal display related to another embodiment of the present invention;

FIG. 5 is a cross-section diagram of a liquid crystal display related to another embodiment of the present invention;

FIG. 6 is a cross-section diagram of a liquid crystal display related to another embodiment of the present invention; and

FIG. 7 is a diagram for explaining the liquid contact angle of the fingerprint adherence prevention surface layer of a liquid crystal display apparatus related to the present invention.

### DESCRIPTION OF THE PREFERRED EMBODIMENTS

The liquid crystal apparatus of the present invention provides a liquid crystal display apparatus that improves transparency without fingerprints adhering because a contrast enhancement film is bonded on an LCD panel, a liquid crystal protective glass is further laminated thereon and a nanoscale fingerprint adhesion prevention surface layer is formed on that surface.

Moreover, the present invention is a liquid crystal display apparatus capable of multi-function key pad display, wherein a fingerprint adherence prevention surface layer is formed into a nanoscale film on the surface of a laminate of an LCD panel, dome substrate, air layer, liquid crystal protective glass, and the like using a method such as vacuum deposition or sputtering taking one or multiple types selected from SiO2, Ti, Sn and the like as the principle components; and can switch and display a variety of differing key top patterns.

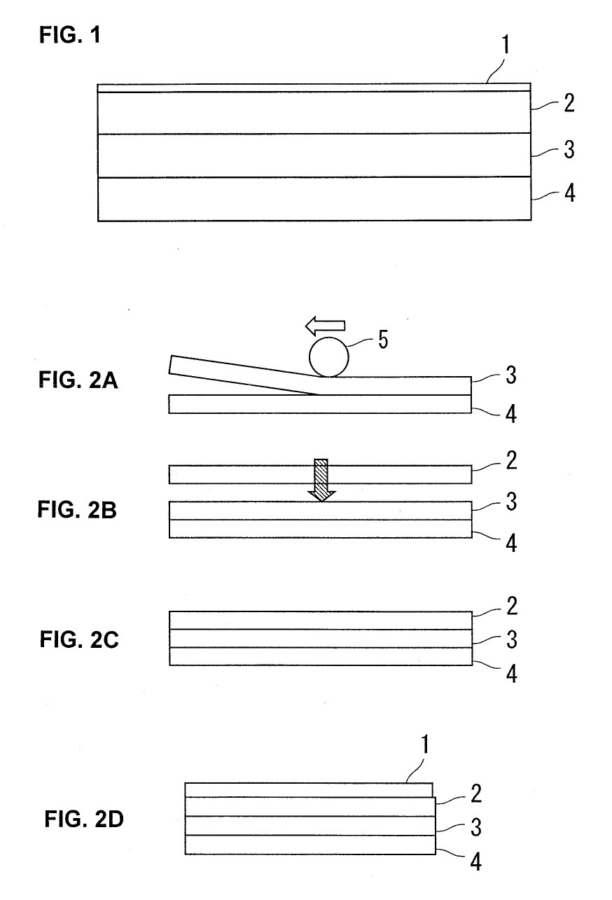

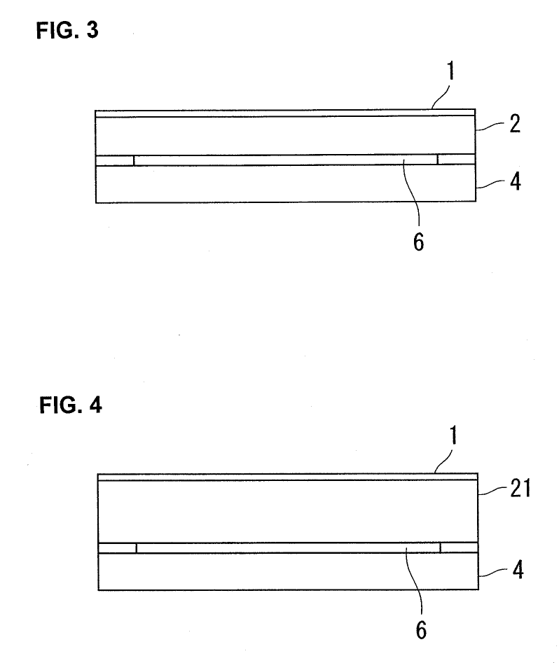

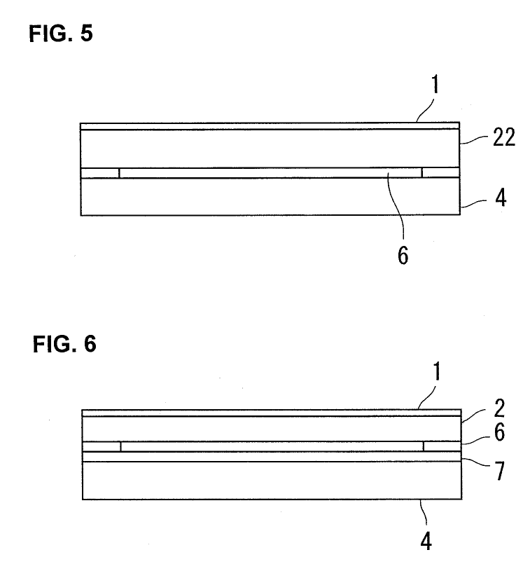

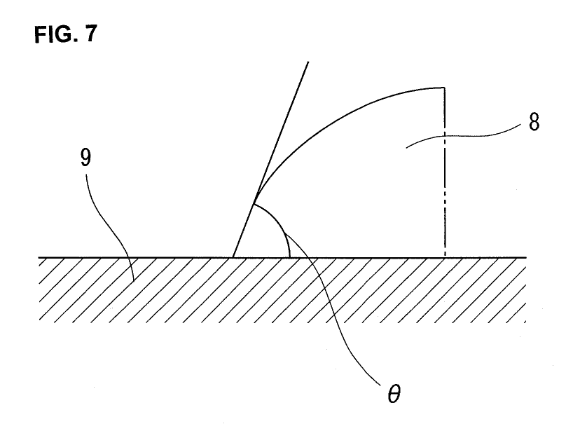

The liquid crystal display apparatus of the present invention will be explained below using the diagrams. Among the diagrams, FIG. 1 is a cross-sectional diagram of a liquid crystal display apparatus related to the present invention. FIG. 2 is a process diagram of the manufacturing of a liquid crystal display apparatus of the present invention, and FIG. 2A is a cross-sectional diagram of the first process of a liquid crystal display apparatus of the present invention. FIG. 2B is a cross-sectional diagram of the second process of a liquid crystal display apparatus of the present invention. FIG. 2C is a cross-sectional diagram of the third process of a liquid crystal display apparatus of the present invention. FIG. 2D is a cross-sectional diagram of the fourth process of a liquid crystal display apparatus of the present invention. FIG. 3 is a cross-sectional diagram of a liquid crystal display apparatus related to another embodiment of the present invention. FIG. 4 is a cross-sectional diagram of a liquid crystal display apparatus related to another embodiment of the present invention. FIG. 5 is a cross-sectional diagram of a liquid crystal display apparatus related to another embodiment of the present invention. FIG. 6 is a cross-sectional diagram of a liquid crystal display apparatus related to another embodiment of the present proposal. FIG. 7 is an explanatory diagram of the liquid contact angle of the fingerprint adherence prevention surface layer of a liquid crystal display apparatus related to the present proposal.

A completed example of the present invention is indicated in the cross-sectional diagram of FIG. 1, and the manufacturing processes leading to the completion diagram of FIG. 1 are explained below in FIGS. 2a to 2d.

Indicated in FIG. 2A is the process of bonding a contrast enhancement film 3 on an LCD panel 4 by means of a roller 5. This process is a general process in apparatuses with paste-on polarization plates in relation to the liquid crystal panel 4.

In the process indicated in FIG. 2B, a liquid crystal protective glass 2 is bonded on top of the contrast enhancement film 3 in a vacuum chamber.

Next, in the process indicated in FIG. 2C, a plurality of sheets is processed for 20 to 30 minutes in an autoclave at 40 to 50° C. at 5 atmospheres.

Next, in the process indicated in FIG. 2D, a fingerprint adhesion prevention surface layer is formed at a nanoscale on the liquid crystal protective glass 2 by vacuum deposition, sputtering or the like using one or multiple types selected from SiO2, Ti, Sn, and the like as the principle component; and a cross-sectional diagram of the completed liquid crystal display apparatus related to the present proposal is indicated in FIG. 1.

### Embodiments

In another embodiment indicated in FIG. 3, there is an air layer 6 between the LCD panel 4 and the liquid crystal protective glass 2, and the fingerprint adherence prevention surface layer is formed at a nanoscale on the surface of the liquid crystal protective glass 2.

In another embodiment indicated in FIG. 3, there is an air layer 6 between the LCD panel 4 and the liquid crystal protective glass 2, and the fingerprint adherence prevention surface layer 1 is formed at a nanoscale on the surface of the liquid crystal protective glass 2.

In another embodiment indicated in FIG. 4, there is an air layer 6 between the LCD panel 4 and an electrostatic capacitance system touch panel 21, and the nanoscale fingerprint adherence prevention surface layer 1 is formed on the surface of the electrostatic capacitance system touch panel 21.

In another embodiment indicated in FIG. 5, there is an air layer 6 between the LCD panel 4 and a resistance film system touch panel 22, and the nanoscale fingerprint adherence prevention surface layer 1 is formed on the surface of the electrostatic capacitance system touch panel 22.

In another embodiment indicated in FIG. 6, a dome substrate 7 is laminated on the LCD panel 4, there is an air layer 6 between the dome substrate 7 and the liquid crystal protective glass 2, and the nanoscale fingerprint adherence prevention surface layer 1 is formed on the surface of the liquid crystal protective glass 2.

FIG. 7 indicates the method of forming the nanoscale fingerprint adherence prevention surface layer 1 on a glass 9, and measuring the contact angle of a water drop 8. The contact angle θ is preferably 110° or more, and the greater the contact angle, the lower the surface energy and the greater the water resistance effect, thus making adherence of fingerprints and contamination more difficult.

The present invention has a contact angle θ of 115°, which is a superior contact angle.

The various characteristic test results of the fingerprint adherence prevention surface layer 1 of the liquid crystal display apparatus of the present invention are as follows. The industrial applicability of the present invention is extremely high because the number of touch panel products that can be mounted in portable telephones, personal computers, car navigation, portable game machines, and the like is increasing, and the adoption of touch panels into electronic equipment that individuals use is spreading rapidly.

### [Weather Resistance and Durability]

There were no changes as a result of leaving outdoors for 2 weeks and measuring the contact angle. Moreover, there were no changes as a result of leaving in a dark box for 34 days and measuring the contact angle. There were no changes as a result of leaving in a car for 34 days and measuring the contact angle.

### [Anti-Abrasion and Chemical-Resistance Tests]

A 500-gram load was applied to an eraser, and after scrubbing back and forth 250 times on the fingerprint adherence prevention surface layer 1, the fingerprint adherence prevention surface layer 1 did not peel off.

Further, the fingerprint adherence prevention surface layer 1 did not peel off even when applying ethyl alcohol so that the surface would not dry out and scrubbing back and forth 250 times.

### [Pencil Hardness Test]

There was no peeling off using a 3 H pencil 400 times or more.

### [Ultraviolet Test Equipment]

After leaving for 72 hours, there was no decoloration, discoloration, checks, bulging, peeling, kinks, or peeling off with tape when comparing before and after.

### [Heat Shock Test]

After leaving at −40° C. for 2 hours, −65° C. for 2 hours, in a chamber for 72 hours, and at room temperature for 4 hours, there was no decoloration, discoloration, checks, bulging, peeling, kinks, or peeling off with tape when comparing before and after.

### [High Temperature, High Humidity Test]

Leaving in conditions of 50° C., 95% RH, for 72 hours and at room temperature for 4 hours, there was no decoloration, discoloration, checks, bulging, peeling, kinks, or peeling off with tape when comparing before and after.

### [Saline Solution Spray Tester]

Leaving at 5% RH, 35° C. for 72 hours, and then rinsing with water, removing the moist air and leaving at room temperature for 4 hours, there was no decoloration, discoloration, checks, bulging, peeling, kinks, or peeling off with tape when comparing before and after.

As explained above, it is expected that the liquid crystal display apparatus of the present proposal will be adopted for touch panels in electronic equipment used by individuals and will be rapidly proliferated, and therefore, will have high industrial applicability in the future.

This application is based on Japanese Patent Application No. 2008-237092, filed on Aug. 19, 2008, the contents of which are incorporated hereinto by reference.

What is claimed is:

1. A liquid crystal display apparatus, wherein a fingerprint adherence prevention surface layer is formed into a nanoscale film on a surface of a laminate of an LCD panel, contrast enhancement film, liquid crystal protective glass, and the like using a method such as vacuum deposition or sputtering, taking one or multiple types selected from SiO2, Ti, Sn and the like as principle components.

2. The liquid crystal display apparatus according to claim 1, wherein the fingerprint adherence prevention layer is formed at a nanoscale on a surface of a laminate of an LCD panel, air layer, liquid crystal protective glass, and the like, or on a surface of a laminate of an LCD panel, air layer, and electrostatic touch panel, and the like, or on a surface of a laminate of an LCD panel, air layer, resistance type touch panel, and the like.

3. A liquid crystal display apparatus capable of multi-function key pad display, wherein a fingerprint adherence prevention surface layer is formed into a nanoscale film on a surface of a laminate of an LCD panel, dome substrate, air layer, liquid crystal protective glass, and the like using a method such as vacuum deposition or sputtering, taking one or multiple types selected from SiO2, Ti, Sn and the like as principle components.
